(19) United States
(12) Patent Application Publication
(10) Pub. No.: US 2015/0355828 A1
(43) Pub. Date: Dec. 10, 2015

(54) OPERATION MODE SWITCHING DEVICE

(71) Applicant: NABTESCO CORPORATION, Tokyo (JP)

(72) Inventor: Yoshinari KIYOMASA, Hyogo (JP)

(21) Appl. No.: 14/729,807

(22) Filed: Jun. 3, 2015

(30) Foreign Application Priority Data
Jun. 6, 2014 (JP) 2014-117592

(51) Int. Cl. G06F 3/0484; G06F 3/0482; G05B 15/02; G06F 3/0481

(52) U.S. Cl. CPC G06F 3/04847; G06F 3/04817; G06F 3/0482; G05B 15/02

(57) ABSTRACT

An operation mode switching device for switching an operation mode of an automatic door includes a display for displaying a home screen for displaying the current operation mode and an icon display control unit for executing a control to display an icon indicating the current operation mode in color on the home screen. Thus, the operation mode of the automatic door can be confirmed even at a remote position.

### TECHNICAL FIELD

The present invention relates to an operation mode switching device for switching an operation mode of an automatic door and displaying the operation mode.

### BACKGROUND ART

Conventionally, an automatic door which operates in a plurality of operation modes is known. These plurality of operation modes include, for example, a two-way mode for enabling passage from indoor to outdoor and from outdoor to indoor, a one-way mode for enabling only passage from indoor to outdoor and a closed mode for blocking exit from indoor to outdoor and entrance from outdoor to indoor. An owner of the automatic door can cause the automatic door to operate in an operation mode corresponding to a situation, for example, by switching each operation mode by an operation mode switching device.

A remote controller including a command switch for selecting and determining each operation mode, a control unit for receiving a signal of the operation mode determined by the command switch and transmitting this signal to a wireless communication module of an automatic door and a display for displaying the determined operation mode in the form of character information is described as a switching device of an automatic door in Japanese Unexamined Patent Publication No. 2008-8082. With the above remote controller, an owner of the automatic door can grasp the current operation mode from the character information displayed on the display and switch the operation mode of the automatic door to the one corresponding to a situation by pressing the command switch if necessary.

The above remote controller is a switching device mainly designed to switch the operation mode. Thus, the display of the above remote controller is provided to enable the owner holding the remote controller in hand to grasp the current operation mode at the time of switching the operation mode. Specifically, the display of the above remote controller is not provided to enable the current operation mode to be grasped at a position remote from the remote controller. Thus, the display of the above remote controller only displays the current operation mode by the character information and it is difficult to identify the character information at the position remote from the remote controller. Therefore, it is difficult to grasp the current operation mode of the automatic door at the position remote from the remote controller.

### SUMMARY OF INVENTION

The present invention was developed in view of the above and aims to provide an operation mode switching device of an automatic door enabling an operation mode of the automatic door to be confirmed even at a remote position.

The present invention is directed to an operation mode switching device for switching an operation mode of an automatic door and includes a display capable of displaying a home screen that displays a current operation mode and an icon display control unit for executing a control to display an icon indicating the current operation mode in color on the home screen.

### BRIEF DESCRIPTION OF DRAWINGS

FIG. 1 is a schematic front view of an automatic door according to an embodiment,

FIG. 2 is a schematic front view of a switching device according to the embodiment,

FIG. 3 is a schematic block diagram showing a control unit and a transmitter/receiver unit in the switching device and a door controller and a transmitter/receiver unit in the automatic door,

FIG. 4 is a schematic transition diagram of screens to be displayed on a display,

FIG. 5 shows a home screen to be displayed on the display in a state where the current operation mode is a one-way mode,

FIG. 6A shows an operation mode selection screen to be displayed on the display in a state where a hold open mode icon is selected, FIG. 6B shows an operation mode selection screen to be displayed on the display in a state where a two-way mode icon is selected, and FIG. 6C shows an operation mode selection screen to be displayed on the display in a state where the two-way mode icon is confirmed on the selection screen of FIG. 6B,

FIG. 7 shows a home screen to be displayed on the display in a state returned to the home screen from the operation mode selection screen of FIG. 6C,

FIG. 8 is a schematic flow chart when an operation mode switching mode M1 is executed,

FIG. 9 shows a maintenance information screen to be displayed on the display,

FIG. 10 is an operation abnormality screen to be displayed on the display,

FIG. 11 is a schematic flow chart when a maintenance information display mode M2 is executed,

FIG. 12 shows a builder menu screen to be displayed on the display,

FIG. 13 shows a large item selection screen to be displayed on the display when “DOOR SETTING” is confirmed on the builder menu screen of FIG. 12,

FIG. 14 shows a small item selection screen to be displayed on the display when “SPEED & TIME” is confirmed on the large item selection screen of FIG. 13,

FIG. 15 shows a parameter setting screen to be displayed on the display when “OP. SPEED” is confirmed on the small item selection screen of FIG. 14,

FIG. 16 is a schematic flow chart when a builder mode M5 is executed, and

FIG. 17 is a schematic flow chart when a developer mode M6 is executed.

### DESCRIPTION OF EMBODIMENT

Hereinafter, one embodiment of the present invention is described with reference to the drawings. Note that the following embodiment is a specific example of the present invention and not of the nature to limit the technical scope of the present invention.

Further, each drawing to be referred to below shows main parts necessary to describe this embodiment in a simplified manner out of constituent parts of this embodiment for convenience of description. Accordingly, an operation mode switching device Y1 of an automatic door X1 according to this embodiment can include arbitrary constituent parts not shown in the drawings to be referred to in this specification. Note that the operation mode switching device Y1 is merely referred to as the switching device Y1 below.

In this embodiment, an automatic door system is configured by the switching device Y1 and the automatic door X1 to which this switching device Y1 is applied.

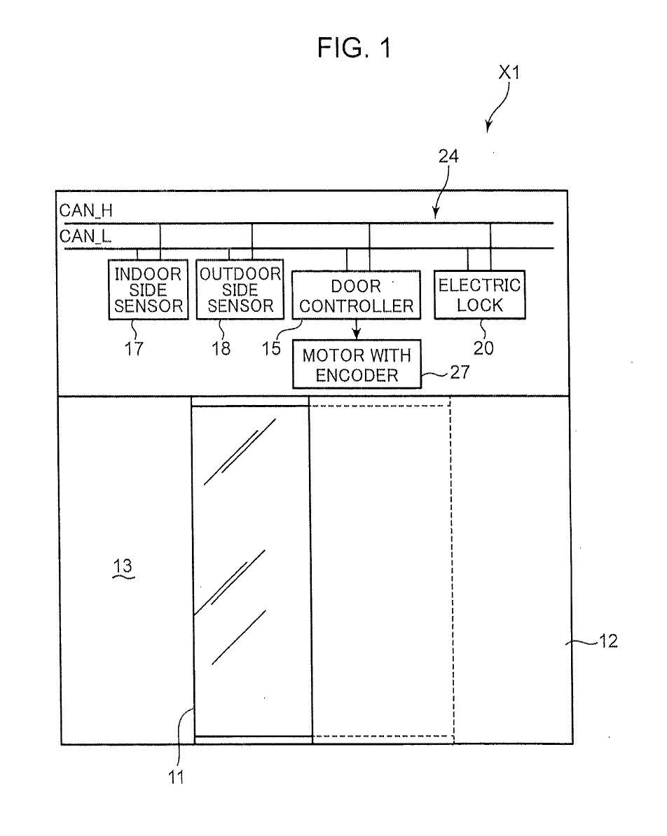

First, the automatic door X1 according to this embodiment is described with reference to FIG. 1. The automatic door X1 is installed, for example, at the entrance of a building with a superintendent and includes a door body 11. Specifically, a frame body is embedded in a wall body of the building and a fixed door 12 is so mounted in this frame body to form an opening 13. The door body 11 of the automatic door X1 is provided to open and close the opening 13 formed in the frame body.

Note that although the automatic door X1 according to this embodiment is a single sliding automatic door in which one door body 11 opens and closes the opening 13, there is no limitation to this and the automatic door X1 may be a dual sliding automatic door including a pair of door bodies.

The automatic door X1 includes a door controller 15, an indoor side sensor 17, an outdoor side sensor 18, an electric lock 20 and a motor with encoder 27. The door controller 15, the indoor side sensor 17, the outdoor side sensor 18, the electric lock 20 and the motor with encoder 27 are housed in a transom installed above the opening 13.

Any of the door controller 15, the indoor side sensor 17 and the outdoor side sensor 18 is connected to a data bus 24. For example, a CAN (Controller Area Network) can be used as this data bus 24. Further, the data bus 24 can be utilized to supply power.

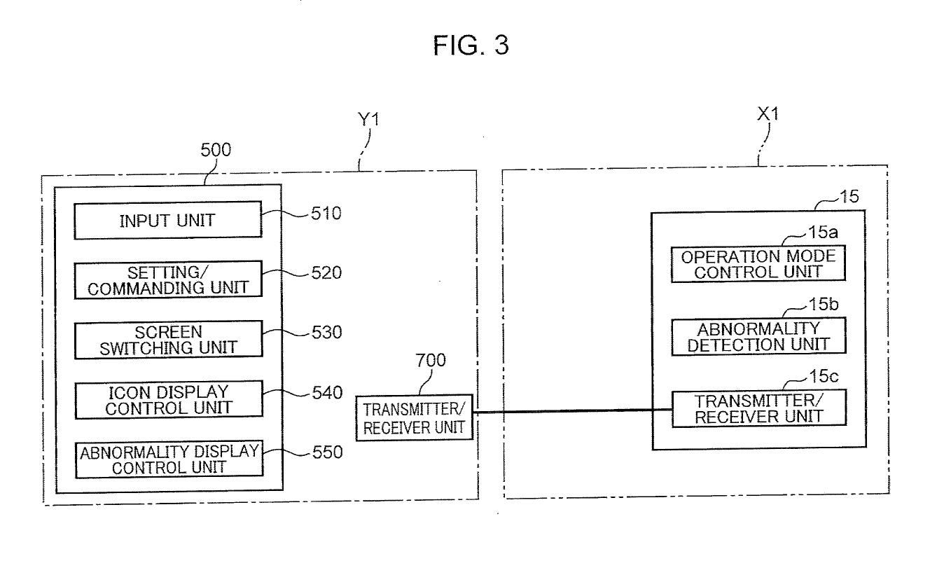

The door controller 15 includes an unillustrated MPU composed of a CPU, a ROM, a RAM, an EEPROM and the like, an unillustrated input/output interface with external devices and the like. The door controller 15 functionally includes an operation mode control unit 15a for executing a control to update an operation mode of the automatic door X1, an abnormality detection unit 15b for detecting an operation abnormality in the automatic door X1 and a transmitter/receiver unit 15c for carrying out communication with the switching device Y1 as shown in FIG. 3. Note that the door controller 15 has only to functionally include the operation mode control unit 15a, the abnormality detection unit 15b and the transmitter/receiver unit 15c and arbitrary means can be adopted to realize these functions. For example, functions corresponding to each of the operation mode control unit 15a, the abnormality detection unit 15b and the transmitter/receiver unit 15c may be realized by software or may be realized by hardware.

The motor with encoder 27 is connected to the door controller 15. The motor with encoder 27 includes a motor as a door engine for moving the door body 11 to open and close and an encoder coupled to a rotary shaft of the motor and electrically connected to the door controller 15. The motor is applied as a drive source for the door body 11 in a driving mechanism of a belt drive type or rack-and-pinion type. Further, the door controller 15 can compute the position of the door body 11 using a signal from the encoder.

In the automatic door X1, the operation mode control unit 15a executes a control to switch the operation mode of the automatic door X1 in response to a command received from a control unit 500 of the switching device Y1. In this way, the automatic door X1 operates in any operation mode selected from a plurality of operation modes. The automatic door X1 according to this embodiment operates in any operation mode out of five operation modes including a hold open mode, a two-way mode, a one-way mode, a hold closed mode and a manual mode. The hold open mode holds the opening 13 in an open state. The two-way mode enables passage in both directions to indoor and outdoor sides across the opening 13. The one-way mode enables passage from indoor to outdoor across the opening 13. The hold closed mode holds the opening 13 in a closed state. The manual mode permits the door body 11 to be only manually opened and closed. Note that the operation modes of the automatic door X1 are not limited to the above five operation modes and can be appropriately added or changed according to a usage mode of this automatic door X1. For example, an operation mode enabling only passage from outdoor to indoor across the opening 13 may be added.

The indoor side sensor 17 is an area sensor for detecting a human or an object in a predetermined area located at an indoor side of the opening 13. On the other hand, the outdoor side sensor 18 is an area sensor for detecting a human or an object in a predetermined area located at an outdoor side of the opening 13. The indoor side sensor 17 and the outdoor side sensor 18 appropriately operate according to the operation mode of the automatic door X1. For example, if the automatic door X1 operates in the one-way mode, the indoor side sensor 17 operates and the outdoor side sensor 18 is rendered inoperable.

The electric lock 20 locks the door body 11. The electric lock 20 includes an unillustrated lock part and an unillustrated lock control unit for controlling this lock part. The electric lock 20 appropriately operates according to the operation mode of the automatic door X1. For example, if the automatic door X1 operates in the hold closed mode, the lock control unit of the electric lock 20 executes a control to actuate the lock part, whereby the door body 11 is locked and held in a state closing the opening 13.

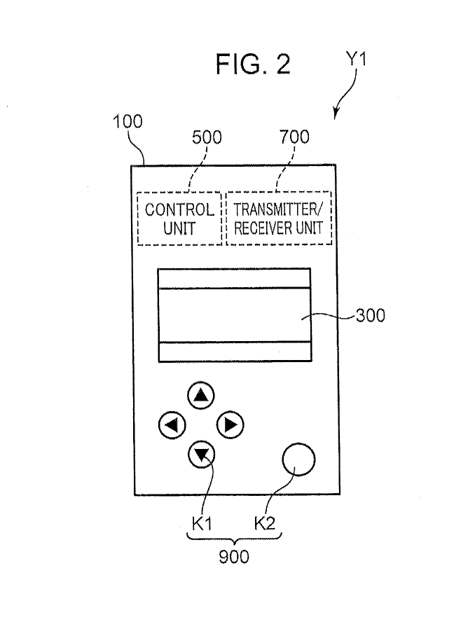

Next, the switching device Y1 according to this embodiment is described with reference to FIG. 2. The switching device Y1 is a device mainly for switching the operation mode of the automatic door X1. The switching device Y1 is installed, for example, on the wall body located near the opening 13. Specifically, the switching device Y1 is installed on the wall body, for example, located laterally to the transom installed above the opening 13.

The switching device Y1 includes a casing 100, a display 300, the control unit 500, a transmitter/receiver unit 700 and an operation unit 900.

The casing 100 functions to hold the display 300, the control unit 500 and the operation unit 900. The casing 100 has a front surface part surrounding the display 300. Specifically, the casing 100 has the front surface part formed with a rectangular opening and the display 300 is exposed from the casing 100 in this opening.

The operation unit 900 includes four direction keys K1 of UP, DOWN, LEFT and RIGHT and an enter key K2. Any of the direction keys K1 and the enter key K2 is provided on the front surface part of the casing 100. When a user of the switching device Y1 operates the direction key K1 and the enter key K2, this switching device Y1 makes a predetermined movement.

The display 300 normally displays a home screen for displaying the current operation mode of the automatic door X1. The user of the switching device Y1 can cause the home screen to transition to any one of a plurality of display screens by operating the operation unit 900. For example, a display capable of color display such as a liquid crystal display with a color filter or an organic EL display can be adopted as the display 300.

The control unit 500 includes an unillustrated MPU composed of a CPU, a ROM, a RAM, an EEPROM and the like.

The control unit 500 exhibits predetermined functions, for example, by executing a program stored in the ROM. As shown in FIG. 3, an input unit 510, a setting/commanding unit 520, a screen switching unit 530, an icon display control unit 540 and an abnormality display control unit 550 are included as these functions.

The input unit 510 receives various output signals from the direction key K1 or the enter key K2 and transmits a signal corresponding to each output signal to the setting/commanding unit 520, the screen switching unit 530 or the icon display control unit 540 when the user operates the direction key K1 or the enter key K2.

The setting/commanding unit 520 generates a command for causing the operation mode control unit 15a of the door controller 15 to update the operation mode of the automatic door X1 in response to a signal received from the input unit 510. This command is transmitted to the operation mode control unit 15a via the transmitter/receiver units 700, 15c. Further, the setting/commanding unit 520 generates a command for causing the operation mode control unit 15a of the door controller 15 to update a control parameter of the operation mode of the automatic door X1 in response to a signal received from the input unit 510.

The transmitter/receiver unit 700 in the switching device Y1 and the transmitter/receiver unit 15c in the automatic door X1 are, for example, wired via the data bus 24. Note that the transmitter/receiver unit 700 in the switching device Y1 and the transmitter/receiver unit 15c in the automatic door X1 may be wirelessly connected.

The screen switching unit 530 executes a control to switch a display screen displayed on the display 300 to a predetermined display screen in response to a signal received from the input unit 510.

The icon display control unit 540 executes a control to change types, colors, sizes or the like of icons in the display screen displayed on the display 300 in response to a signal received from the input unit 510.

Note that the control unit 500 has only to functionally include the input unit 510, the setting/commanding unit 520, the screen switching unit 530, the icon display control unit 540 and the abnormality display control unit 550 and arbitrary means can be adopted to realize these functions. For example, functions corresponding to each of the input unit 510, the setting/commanding unit 520, the screen switching unit 530, the icon display control unit 540 and the abnormality display control unit 550 may be realized by software or may be realized by hardware. Further, the functions corresponding to each of the input unit 510, the setting/commanding unit 520, the screen switching unit 530, the icon display control unit 540 and the abnormality display control unit 550 may be realized individual functional components or may be realized by a common functional component.

The switching device Y1 can execute an operation mode switching mode M1 of the automatic door X1, a maintenance information display mode M2 of the automatic door X1, an opening changing mode M3 of the door body 11 in the automatic door X1, various setting changing modes M4, a builder mode M5 for setting a control parameter of the operation mode of the automatic door X1 and a developer mode M6 for confirming detailed information of the automatic door X1.

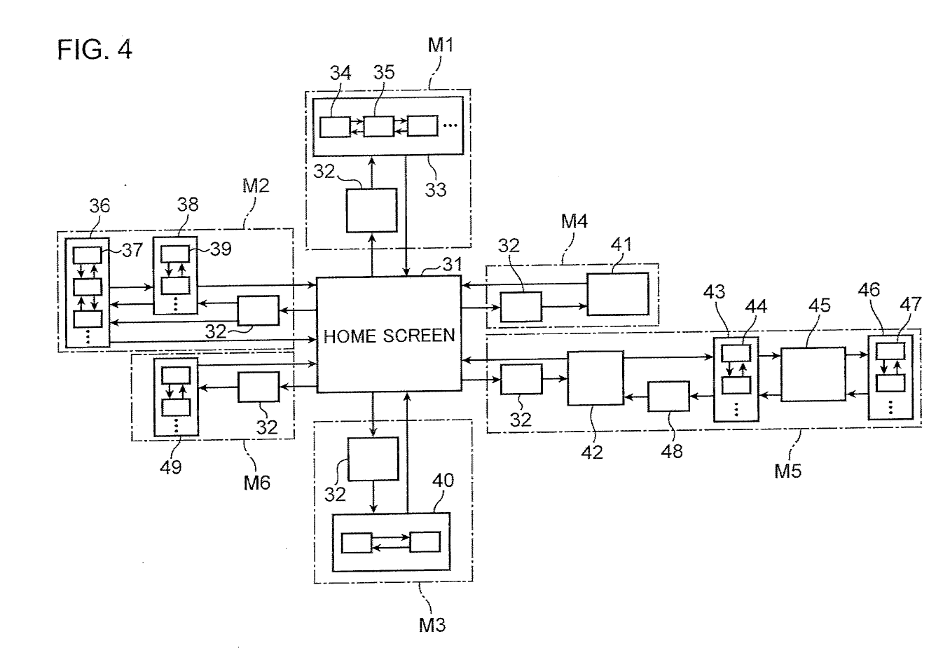

Specifically, as shown in FIG. 4, the switching device Y1 can execute any one of the modes M1 to M6 through the operation of the operation unit 900 by the user in a state where a home screen 31 is displayed on the display 300. More specifically, the operation mode switching mode M1 is executable on the condition that the direction key K1 indicating an upward direction is pressed in the state where the home screen 31 is displayed on the display 300. Further, the maintenance information display mode M2 is executable on the condition that the direction key K1 indicating a leftward direction is pressed twice. Further, the opening changing mode M3 is executable on the condition that the direction key K1 indicating a downward direction is pressed. Further, the setting changing mode M4 is executable on the condition that the direction key K1 indicating a rightward direction is pressed twice. Further, the builder mode M5 is executable on the condition that the direction key K1 indicating the rightward direction is pressed long. Further, the developer mode M6 is executable on the condition that the direction key K1 indicating the leftward direction is pressed long. Note that a way of operating the direction K1 pressed to make each mode M1 to M6 executable is not limited to the above and can be appropriately changed according to a usage mode of the switching device Y1.

A transition of screens displayed on the display 300 in the case of executing each mode M1 to M6 in the switching device Y1 is described below with reference to FIG. 4.

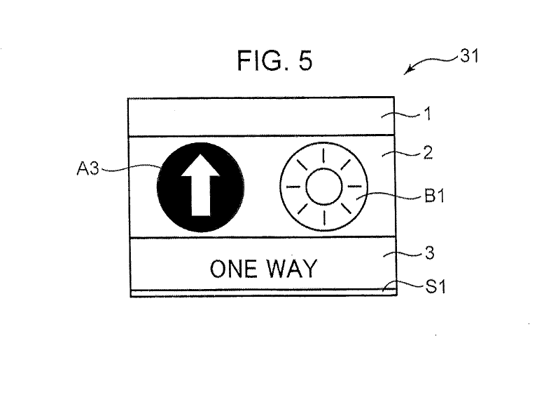

First, the home screen 31 shown in FIG. 5 is displayed on the display 300. The home screen 31 is a screen displayed on the display 300 in a normal state, i.e. in a state before the switching device Y1 is caused to function in each mode M1 to M6.

The home screen 31 includes a screen name display area 1 located in an upper part of this home screen 31, an icon display area 2 located in a middle part of this home screen 31, a name display area 3 located in a lower part of the home screen 31 and a non-display area S1 located below the name display area 3 and extending along a lower edge of the casing 100 surrounding the display 300.

An icon indicating the current operation mode, which is the currently set operation mode, and an icon indicating the current opening are displayed in color in the icon display area 2 of the home screen 31. A one-way mode icon A3 displayed in the icon display area 2 of the home screen 31 indicates that the current operation mode is the one-way mode. Further, a full open icon B1 displayed in the icon display area 2 of the home screen 31 indicates that the current opening is a full opening.

Characters “ONE WAY” is displayed as character information representing the one-way mode icon A3 displayed in the icon display area 2 in the name display area 3 of the home screen 31.

The non-display area S1 is an area where various pieces of information such as icons and characters displayed on the home screen 31 are not displayed. Specifically, the non-display area S1 extending along the lower edge of the casing 100 is an empty space on the home screen 31.

Note that since the switching device Y1 does not function in any of the modes M1 to M6 in the state where the home screen 31 is displayed on the display 300, nothing is displayed in the screen name display area 1 of the home screen 31.

Here, when the direction key K1 indicating the upward direction is pressed out of the four direction keys K1 of UP, DOWN, LEFT and RIGHT in the state where the home screen 31 is displayed on the display 300, the operation mode switching mode M1 is executable.

Specifically, when the direction key K1 indicating the upward direction is pressed in the state where the home screen 31 is displayed on the display 300, the home screen 31 transitions to a pass code screen 32 as shown in FIG. 4. Then, the user of the switching device Y1 enters a predetermined pass code by operating the direction keys K1 and the enter key K2 in the state where the pass code screen 32 is displayed on the display 300. In this way, the pass code screen 32 transitions to an operation mode selection screen 33. Note that the pass code screen 32 may not be provided and the home screen 31 may transition to the operation mode selection screen 33 by pressing the direction key K1 indicating the upward direction in the state where the home screen 31 is displayed on the display 300.

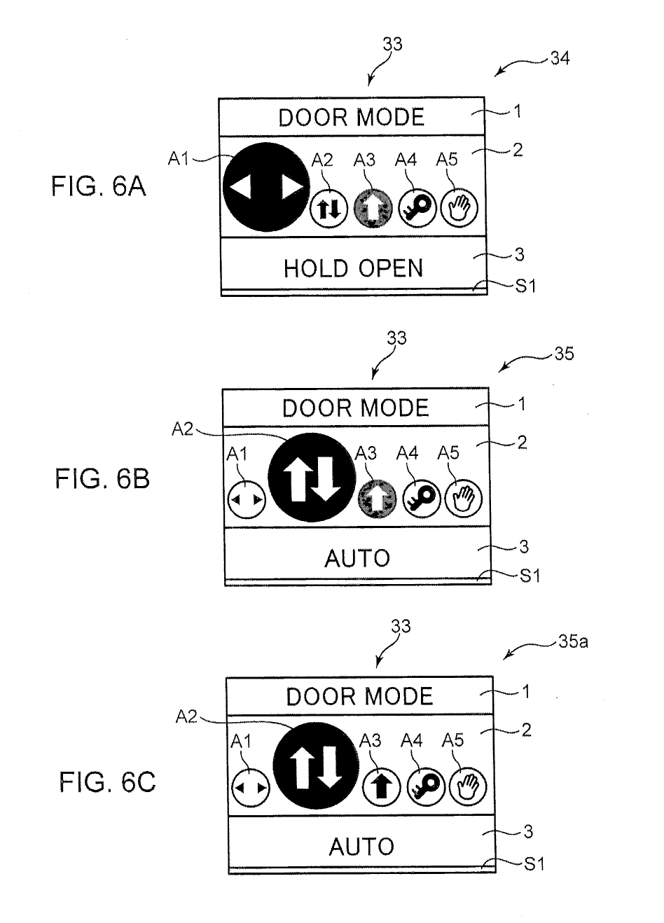

Here, the operation mode selection screen 33 in a state where a hold open mode icon A1 is selected is denoted by reference sign 34 in FIG. 6A. The operation mode selection screen 33 includes a screen name display area 1, an icon display area 2, a name display area 3 and a non-display area S1 similarly to the home screen 31.

Characters “DOOR MODE” are displayed as character information representing that the current screen is an operation mode selection screen 34 in the screen name display area 1 of the operation mode selection screen 33.

Icons indicating various operation modes selectable on this operation mode selection screen 33 by the user are displayed in the icon display area 2 of the operation mode selection screen 33. These icons include the hold open mode icon A1, a two-way mode icon A2, the one-way mode icon A3, a hold closed mode icon A4 and a manual mode icon A5. When the direction key K1 indicating the leftward or rightward direction is pressed in the state where the operation mode selection screen 33 is displayed on the display 300, the icons A1 to A5 are successively selected. Note that the current operation mode is not changed in such a stage of selecting the icon A1 to A5.

Out of the icons A1 to A5, the currently selected hold open mode icon A1 is displayed larger than the other icons A2 to A5 on the operation mode selection screen 34. Further, out of the icons A1 to A5, the currently selected hold open mode icon A1 and the one-way mode icon A3 indicating the current operation mode are displayed in saturation or brightness different from that of the other icons A2, A4 and A5. In this embodiment, the icons A1, A3 are displayed in color and the other icons A2, A4 and A5 are monochromatically displayed. Further, out of the icons A1 to A5, the currently selected hold open mode icon A1 and the one-way mode icon A3 indicating the current operation mode are displayed in different colors.

Characters “HOLD OPEN” are displayed as character information representing the currently selected hold open mode icon A1 out of the icons A1 to A5 in the name display area 3 of the operation mode selection screen 34.

Here, when the direction key K1 indicating the rightward direction is pressed in the state where the operation mode selection screen 34 is displayed on the display 300, the operation mode selection screen 34 becomes an operation mode selection screen 35 on which the two-way mode icon A2 is displayed larger than the other icons A1, A3 to A5 as shown in FIG. 6B. In this state where the operation mode selection screen 35 is displayed on the display 300, the two-way mode icon A2 is selected out of the icons A1 to A5. In this way, the user of the switching device Y1 can select any one of the icons A1 to A5 by operating the direction key K1 indicating the leftward or rightward direction on the operation mode selection screen 33.

Note that, in this embodiment, the color of each icon A1 to A5 selected by operating the direction key K1 indicating the leftward or rightward direction on the operation mode selection screen 33 is the same as that displayed on the home screen 31. Further, the colors of the selected icons A1 to A5 are different from each other. Further, each selected icon A1 to A5 may be displayed in a single color or may be displayed in a combination of a plurality of different colors.

When the enter key K2 is pressed in the state where the operation mode selection screen 35 with the selected two-way mode icon A2 is displayed on the display 300, the operation mode indicated by the two-way mode icon A2 is confirmed as the current operation mode. In this way, the operation mode of the automatic door X1 is updated from the one-way mode to the two-way mode. Then, the one-way mode icon A3 on the operation mode selection screen 35 is changed from color display to monochromatic display as the current operation mode is updated to the two-way mode. FIG. 6C shows the operation mode selection screen 33 at this time as an operation mode selection screen 35a.

On the operation mode selection screen 35a, the two-way mode icon A2 is the currently selected icon and an icon corresponding to the current operation mode. Thus, only the two-way mode icon A2 is displayed in color. Note that when the direction key K1 indicating the rightward direction is, for example, pressed in the state where the operation mode selection screen 35a is displayed on the display 300, the one-way mode icon A3 is displayed in color as the currently selected icon and the two-way mode icon A2 is displayed in color as an icon corresponding to the current operation mode.

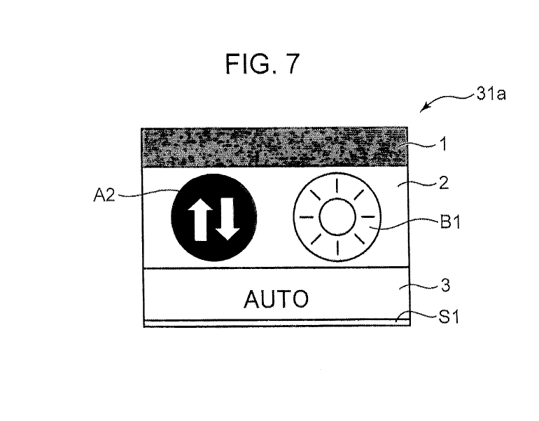

When the direction key K1 indicating the downward direction is pressed in the state where the operation mode selection screen 35a is displayed on the display 300 after the operation mode is updated as described above, this operation mode selection screen 35a transitions to a home screen 31a shown in FIG. 7. The two-way mode icon A2 is displayed in color instead of the one-way mode icon A3 in an icon display area 2 of this home screen 31a. The color of the two-way mode icon A2 displayed on the home screen 31a is different from that of the one-way mode icon A3 displayed on the home screen 31.

Note that FIG. 7 shows a case where a screen name display area 1 of the home screen 31a is displayed in color different from that of the screen name display area 1 of the home screen 31. This indicates the occurrence of an operation abnormality in the automatic door X1. Specifically, in the event of no operation abnormality in the automatic door X1, the screen name display area 1 of the home screen 31a is in the same color as the screen name display area 1 of the home screen 31. Contrary to this, in the event of an operation abnormality in the automatic door X1, the color of the screen name display area 1 of the home screen 31a is displayed in color different from that of the screen name display area 1 of the home screen 31. Specifically, the occurrence of the operation abnormality is notified to the user.

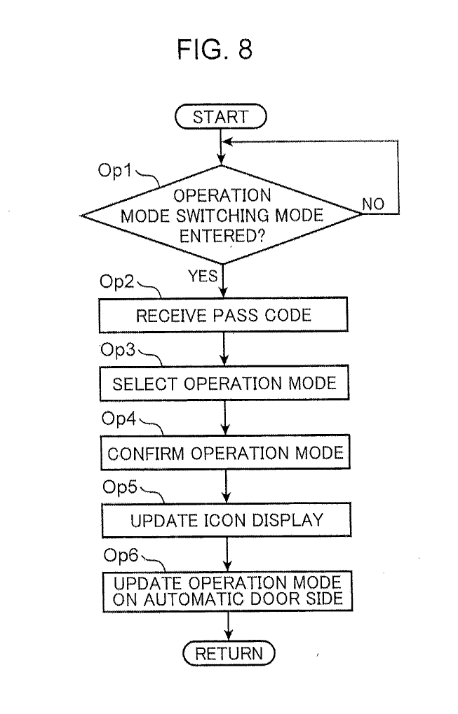

Here, the operation of the switching device Y1 in executing the operation mode switching mode M1 is described with reference to a flow chart shown in FIG. 8.

First, the operation is started in the state where the home screen 31 is displayed on the display 300. The input unit 510 determines whether or not a signal for executing the operation mode switching mode M1 has been input (Op1) in the state where the home screen 31 is displayed on the display 300. When the user presses the direction key K1 indicating the upward direction, a signal for executing the operation mode switching mode M1 is output from this direction key K1. This signal is a signal for switching the home screen 31 displayed on the display 300 to another display screen. The input unit 510 sends a command to the screen switching unit 530 to execute a control to switch the home screen 31 to the pass code screen 32 when receiving the signal (YES in Op1). When the user enters a predetermined pass code by pressing the direction keys K1 and the enter key K2 in the state where the pass code screen 32 is displayed on the display 300, the input unit 510 receives this (Op2). The input unit 510 having received the predetermined pass code sends a command to the screen switching unit 530 to execute a control to switch the pass code screen 32 to the operation mode selection screen 33.

Note that, in this embodiment, three first to third pass codes are set as the pass codes for switching the pass code screen 32 to the operation mode selection screen 33. Specifically, in the switching device Y1, the screen switching unit 530 permits the switch of the home screen 31 to the operation mode selection screen 33 via the pass code screen 32 on the condition that the input unit 510 has received the entry of the first, second or third pass code.

Here, the first pass code is a pass code assigned to the owner of the automatic door X1, the second pass code is a pass code assigned to a builder of the automatic door X1 and the third pass code is a pass code assigned to a developer of the automatic door X1. Specifically, in this embodiment, all of the owner, the builder and the developer can switch the home screen 31 to the operation mode selection screen 33. In this embodiment, the pass code screen 32 is switched to the operation mode selection screen 34 in a state where the hold open mode icon A1 is selected.

When the user presses the direction key K1 indicating the rightward direction in the state where the operation mode selection screen 34 is displayed on the display 300, a signal is output from this direction key K1. The input unit 510 sends a command to the icon display control unit 540 when receiving the signal. This command is a command for executing a control to display the two-way mode icon A2 located to the right of the hold open mode icon A1 selected on the operation mode selection screen 34 out of the icons A1 to A5 larger than the other icons A1 and A3 to A5. The icon display control unit 540 having received the above command executes the control to display the two-way mode icon A2 larger than the other icons A1 and A3 to A5 and also executes a control to color-display the two-way mode icon A2 and the one-way mode icon A3 indicating the current operation mode in saturation or brightness different from that of the other icons A1, A4 and A5. In this way, the operation mode selection screen 33 displayed on the display 300 is switched from the operation mode selection screen 34 in a state where the hold open mode icon A1 is selected to the operation mode selection screen 35 in a state where the two-way mode con A2 is selected. By repeating such an operation, each operation mode of the automatic door X1 can be selected on the operation mode selection screen 33 (Op3).

Note that the icon display control unit 540 displays the icons A1 to A5 in colors different from each other in color-displaying any of the icons A1 to A5 displayed on the operation mode selection screen 33. Thus, the two-way mode icon A2 selected on the operation mode selection screen 35 and the one-way mode icon A3 indicating the current operation mode are displayed in colors different from each other.

When the user presses the enter key K2 in the state where the operation mode selection screen 35 is displayed on the display 300, a confirmation signal of the operation mode is output from this enter key K2 (Op4). The input unit 510 sends a command to the icon display control unit 540 when receiving the above confirmation signal of the operation mode. This command is a command for executing a control to display the one-way mode icon A3 in saturation or brightness different from that of the currently selected two-way mode icon A2 and executing a control to display the currently selected two-way mode icon A2 in color as a new current operation mode. In this way, the display of the icons is updated and the operation mode selection screen 35 becomes the operation mode selection screen 35a (Op5).

Further, the input unit 510 sends a command to the setting/commanding unit 520 when receiving the above confirmation of the operation mode. The setting/commanding unit 520 having received the above command generates a command for updating the operation mode of the automatic door X1. This command is transmitted to the operation mode control unit 15a via the transmitter/receiver units 711 and 15c. In this way, the operation mode control unit 15a executes a control to update the operation mode of the automatic door X1 from the one-way mode to the two-way mode (Op6).

When the user presses the direction key K1 indicating the downward direction in the state where the operation mode selection screen 33 is displayed on the display 300 after the operation mode of the automatic door X1 is updated in this way, the input unit 510 sends a command to the screen switching unit 530 to execute a control to switch the operation mode selection screen 33 to the home screen 31a. The screen switching unit 530 having received the above command executes the control to switch the operation mode selection screen 33 to the home screen 31a.

At this time, the icon display control unit 540 executes a control to color-display the two-way mode icon A2 confirmed in Op4, instead of the one-way mode icon A3 on the home screen 31, as the current operation mode on the home screen 31a. Note that the icon display control unit 540 executes a control to display the icons A1 to A5 in colors different from each other in color-displaying any of the icons A1 to A5 on the home screen 31a.

Note that the abnormality detection unit 15b of the door controller 15 outputs an operation abnormality signal to the transmitter/receiver unit 700 via the transmitter/receiver unit 15c when detecting an operation abnormality of the automatic door X1. Then, the abnormality display control unit 550 receives the above operation abnormality signal via the transmitter/receiver unit 700 and executes a control to display the screen name display area 1 of the home screen 31a in color different from that of the screen name display area 1 of the home screen 31.

By displaying the home screen 31a on the display 300 in this way, the operation mode switching mode M1 in the switching device Y1 is finished.

Next, a transition of screens displayed on the display 300 in the case of executing the maintenance information display mode M2 is described.

When the direction key K1 indicating the leftward direction out of the four direction keys of UP, DOWN, LEFT and RIGHT is pressed twice in the state where the home screen 31 is displayed on the display 300, the switching device Y1 functions in the maintenance information display mode M2.

Specifically, when the direction key K1 indicating the leftward direction is pressed twice in the state where the home screen 31 is displayed on the display 300, the home screen 31 transitions to the pass code screen 32. Then, when the user of the switching device Y1 enters a predetermined pass code by operating the direction keys K1 and the enter key K2, the pass code screen 32 transitions to a maintenance information screen 36 or an operation abnormality screen 38. Specifically, the pass code screen 32 transitions to the maintenance information screen 36 if there is no operation abnormality in the automatic door X1, and the pass code screen 32 transitions to the operation abnormality screen 38 if there is an operation abnormality in the automatic door X1. Note that the pass code screen 32 may not be provided and the home screen 31 may transition to the maintenance information screen 36 or the operation abnormality screen 38 by pressing the direction key K1 indicating the leftward direction twice in the state where the home screen 31 is displayed on the display 300.

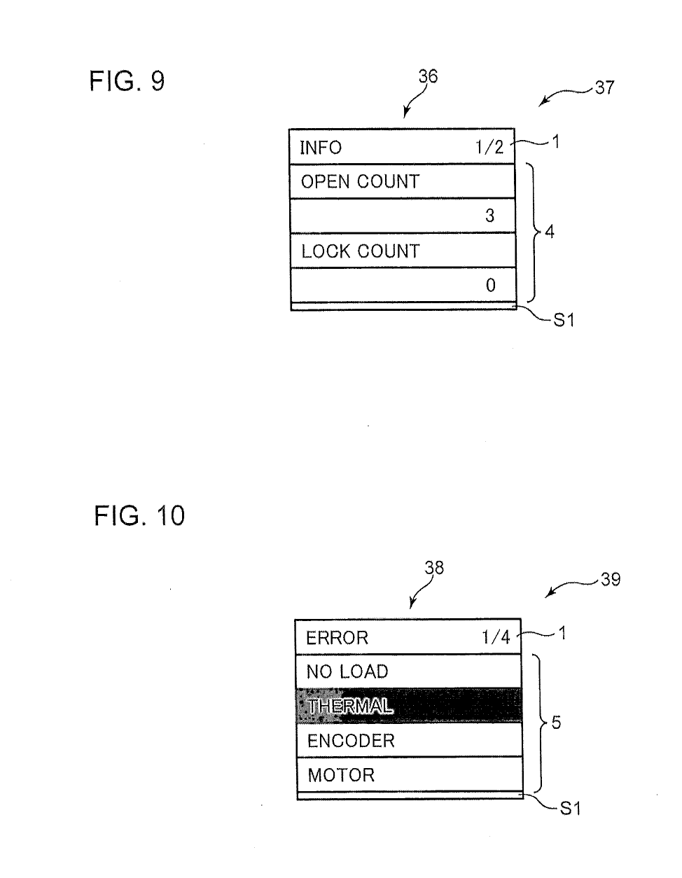

The maintenance information screen 36 is a screen on which information on the maintenance of the automatic door X1 is displayed. Here, FIG. 9 shows a maintenance information screen 37 which is a next page screen of the maintenance information screen 36. The maintenance information screen 37 includes a screen name display area 1, an information display area 4 and a non-display area S1.

A character “INFO” as character information representing that the current screen is the maintenance information screen 37 and the number of pages of this maintenance information screen 37 are displayed in the screen name display area 1 of the maintenance information screen 37.

Information on how many times the door body 11 of the automatic door X1 has been opened and closed and information on how many times the door body 11 has been locked by the electric lock 20 are displayed in the information display area 4 of the maintenance information screen 37. These pieces of information are referred to at the time of the maintenance of the automatic door X1. The display in the information display area 4 of the maintenance information screen 37 is appropriately updated in accordance with a signal transmitted from the door controller 15 via the transmitter/receiver units 15c and 700.

When the direction key K1 indicating the upward or downward direction is pressed in the state where the maintenance information screen 37 is displayed on the display 300, this maintenance information screen 37 transitions to the next page. For example, the door controller 15, program version information of the door controller 15 or the like is displayed on this next page.

Further, FIG. 10 shows an operation abnormality screen 39 which is a predetermined page screen of the operation abnormality screen 38. The operation abnormality screen 39 includes a screen name display area 1, an operation abnormality display area 5 and a non-display area S1.

A character “ERROR” as character information representing that the current screen is the operation abnormality screen 39 and the number of pages of this operation abnormality screen 39 are displayed in the screen name display area 1 of the operation abnormality screen 39.

Operation abnormality items in the automatic door X1 are displayed in the operation abnormality display area 5 of the operation abnormality screen 39. In this embodiment, an item “THERMAL” out of four operation abnormality items displayed on the operation abnormality screen 39 is displayed in color. With this, it can be determined that the motor of the motor with encoder 27 is in a high temperature state.

When the direction key K1 indicating upward or downward direction is pressed in a state where the operation abnormality screen 39 is displayed on the display 300, this operation abnormality screen 39 transitions to the next page. Operation abnormality items other than those displayed on the operation abnormality screen 39 are displayed on the next page. The operation abnormality items displayed on the operation abnormality screen 38 include, for example, the following items.

TABLE 1

| | |
|---|---|
| No Load Error | Occurring when the motor is idly rotated for a long |
| (NO LOAD) | time. |
| Thermal Operation | Occurring when the motor becomes hot. |
| (THERMAL) | |
| Encoder Error | Occurring when there is an abnormality in an |
| (ENCODER) | encoder signal of the motor. |
| Motor Error | Occurring when there is an abnormality in a motor |
| (MOTOR) | driver. |
| Motor Non- | Occurring when a motor line is unconnected or |
| Connection Error | broken. |
| Safety Warning | Occurring when the door is successively moved a |
| | predetermined number of times or more in opposite |
| | direction. |
| RAM Error | Occurring when there is an abnormality in the RAM |
| | in the controller. |
| ROM Error | Occurring when there is an abnormality in the ROM |
| | in the controller. |
| EEPROM Error | Occurring when there is an abnormality in the |
| | EEPROM in the controller. |
| Input S1 Sensor | Occurring when a self-diagnosis error from a sensor |
| Error | connected to an input S1 is caught. |
| Input S2 Sensor | Occurring when a self-diagnosis error from a sensor |
| Error | connected to an input S2 is caught. |
| Electric Lock Error | Occurring when there is an abnormality in the |
| | electric lock |
| NET | Occurring at the time of a communication error |
| Communication | between NET devices due to a possibility of noise or |
| Error | error wiring. |
| NET Device | Occurring at the time of a communication error |
| Connection Error | between NET devices due to a possibility of NET |
| | cable breakage. |
| NET Transmission | Occurring when data cannot be transmitted for a |
| Delay Error | fixed period due to noise or the like. |
| NET Reception | Occurring when communication traffic is large. |
| Buffer Error | |

When the direction key K1 indicating the leftward direction is pressed in a state where any one of the pages of the operation abnormality screen 38 is displayed on the display 300, the operation abnormality screen 38 transitions to the maintenance information screen 36.

Here, if the display screen displayed on the display 300 directly transitions from the pass code screen 32 to the maintenance information screen 36, the maintenance information screen 36 transitions to the home screen 31 when the direction key K1 indicating the rightward direction is pressed in the state where the maintenance information screen 36 is displayed.

On the other hand, if the display screen displayed on the display 300 transitions from the pass code screen 32 to the maintenance information screen 36 via the operation abnormality screen 38, the maintenance information screen 36 transitions to the operation abnormality screen 38 when the direction key K1 indicating the rightward direction is pressed in the state where the maintenance information screen 36 is displayed. Then, by pressing the direction key K1 indicating the rightward direction in the state where the operation abnormality screen 38 is displayed on the display 300, this operation abnormality screen 38 transitions to the home screen 31.

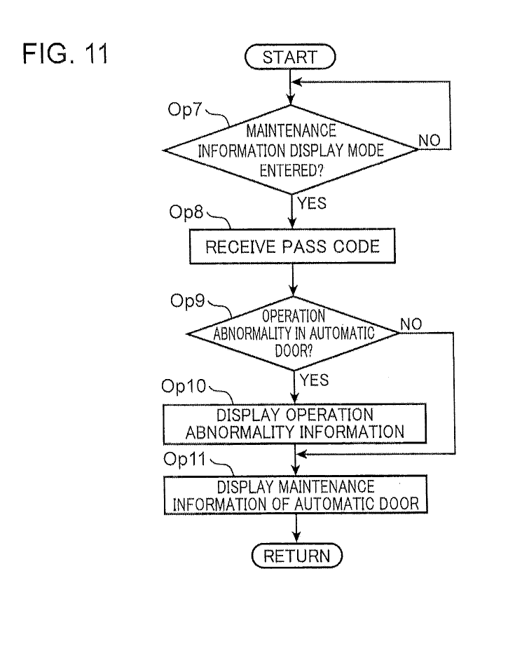

Here, the operation of the switching device Y1 in executing the maintenance information display mode M2 is described with reference to a flow chart shown in FIG. 11.

First, the operation is started in the state where the home screen 31 is displayed on the display 300. The input unit 510 determines whether or not a signal for executing the maintenance information display mode M2 has been input (Op7) in the state where the home screen 31 is displayed on the display 300. When the user presses the direction key K1 indicating the leftward direction twice, a signal for executing the maintenance information display mode M2 is output from this direction key K1. This signal is also a signal for switching the home screen 31 displayed on the display 300 to another display screen. The input unit 510 sends a command to the screen switching unit 530 to execute the control to switch the home screen 31 to the pass code screen 32 when receiving the above signal (YES in Op7). When the user enters a predetermined pass code by pressing the direction keys K1 and the enter key K2 in the state where the pass code screen 32 is displayed on the display 300, the input unit 510 receives the predetermined pass code (Op8). The input unit 510 having received the predetermined pass code sends a command to the screen switching unit 530 to execute a control to switch the pass code screen 32 to the maintenance information screen 36 or the operation abnormality screen 38.

Note that, in this embodiment, the three first to third pass codes are set as the pass codes for switching the pass code screen 32 to the maintenance information screen 36 or the operation abnormality screen 38. Specifically, in the switching device Y1, the screen switching unit 530 permits the switch of the home screen 31 to the maintenance information screen 36 or the operation abnormality screen 38 via the pass code screen 32 on the condition that the input unit 510 has received the entry of the first, second or third pass code. In this embodiment, all of the owner, the builder and the developer can switch the home screen 31 to the maintenance information screen 36 or the operation abnormality screen 38.

The screen switching unit 530 having received the above command from the input unit 510 executes a control to select a screen to be switched from the pass code screen 32 according to the presence or absence of the operation abnormality information of the automatic door X1. Specifically, the screen switching unit 530 having received the above command confirms via the transmitter/receiver units 700 and 15c whether or not the operation abnormality information of the automatic door X1 is saved in the abnormality detection unit 15b of the door controller 15.

The screen switching unit 530 executes a control to switch the pass code screen 32 to the operation abnormality screen 38 when the above operation abnormality information is present (YES in Op9). The operation abnormality item corresponding to the operation abnormality information is displayed in color on the operation abnormality screen 38. In this way, the operation abnormality screen 38 is displayed on the display 300 (Op10).

Then, when the user presses the direction key K1 indicating the leftward direction in the state where the operation abnormality screen 38 is displayed on the display 300, the input unit 510 sends a command to the screen switching unit 530 to execute a control to switch the operation abnormality screen 38 to the maintenance information screen 36. In this way, the maintenance information screen 36 is displayed on the display 300 (Op11).

On the other hand, the screen switching unit 530 executes a control to switch the pass code screen 32 to the maintenance information screen 36 when the above operation abnormality information is absent (NO in Op9). In this way, the maintenance information screen 36 is displayed on the display 300 (Op11).

Here, if the direction key K1 indicating the rightward direction is pressed when the operation abnormality information is saved in the abnormality detection unit 15b (YES in Op9) and the pass code screen 32 is switched to the maintenance information screen 36 by way of the operation abnormality screen 38, the input unit 510 having received a signal from this direction key K1 sends a command to the screen switching unit 530 to execute a control to switch the maintenance information screen 36 to the operation abnormality screen 38. Thereafter, when the direction key K1 indicating the rightward direction is pressed in the state where the operation abnormality screen 38 is displayed on the display 300, the input unit 510 having received a signal from this direction key K1 sends a command to the screen switching unit 530 to execute a control to switch the operation abnormality screen 38 to the home screen 31.

On the other hand, if the direction key K1 indicating the rightward direction is pressed when the operation abnormality information is not saved in the abnormality detection unit 15b (NO in Op9) and the pass code screen 32 is switched to the maintenance information screen 36 without by way of the operation abnormality screen 38, the input unit 510 having received a signal from this direction key K1 sends a command to the screen switching unit 530 to execute a control to switch the maintenance information screen 36 to the home screen 31.

By displaying the home screen 31 again on the display 300 in this way, the maintenance information display mode M2 is finished.

Next, the execution of the opening changing mode M3 is briefly described. The opening changing mode M3 is executable when the direction key K1 indicating the downward direction out of the four direction keys K1 of UP, DOWN, LEFT and RIGHT is pressed in the state where the home screen 31 is displayed on the display 300. Although the opening changing mode M3 is not described in detail, an opening degree of the door body 11 in the automatic door X1 can be changed on an opening changing screen 40 in this opening changing mode M3. Although the full open icon B1 corresponding to the current opening degree is displayed on the home screen 31 in this embodiment, the full open icon B1 displayed on the display 31 is changed to a half open icon, for example, if the opening degree of the door body 11 is changed to half open on the opening changing screen 40.

Next, the execution of the setting changing mode M4 is briefly described. The setting changing mode M4 is executable when the direction key K1 indicating the rightward direction out of the four direction keys K1 of UP, DOWN, LEFT and RIGHT is pressed twice in the state where the home screen 31 is displayed on the display 300. Although the setting changing mode M4 is not described in detail, various settings such as the operation setting of a key switch menu, the setting of a display time of display screens on the display 300, the setting of the pass code and the setting of a temporary opening of the door body 11 in the hold closed mode can be made in this setting changing mode M4.

Next, a transition of screens displayed on the display 300 in the case of executing the builder mode M5 is described. The builder mode M5 is a mode mainly for setting a control parameter of each operation mode in the automatic door X1 by the builder of the automatic door X1.

When the direction key K1 indicating the rightward direction out of the four direction keys of UP, DOWN, LEFT and RIGHT is pressed long in the state where the home screen 31 is displayed on the display 300, the builder mode M5 is executable.

Specifically, when the direction key K1 indicating the rightward direction is pressed long in the state where the home screen 31 is displayed on the display 300, the home screen 31 transitions to the pass code screen 32. Then, when the builder of the switching device Y1 enters a predetermined pass code by operating the direction keys K1 and the enter key K2, the pass code screen 32 transitions to a builder menu screen 42. Note that the pass code screen 32 may not be provided and the home screen 31 may transition to the builder menu screen 42 by pressing the direction key K1 indicating the rightward direction long in the state where the home screen 31 is displayed on the display 300.

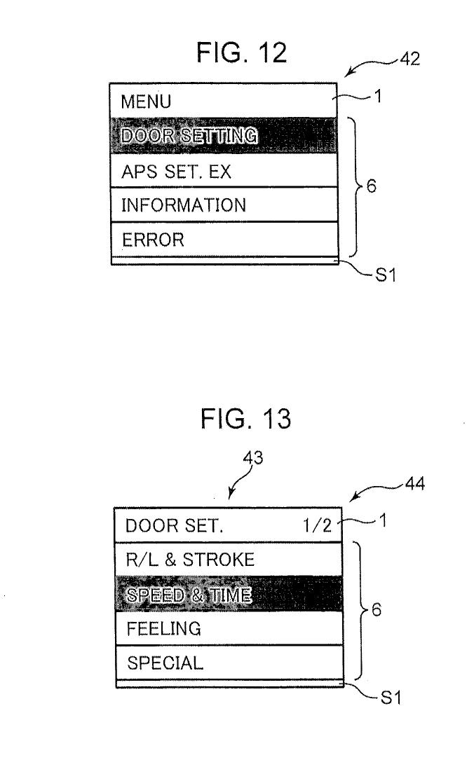

Here, FIG. 12 shows the builder menu screen 42. The builder menu screen 42 includes a screen name display area 1, a menu display area 6 and a non-display area S1.

A character “MENU” is displayed as character information representing that the current screen is the builder menu screen in the screen name display area 1 of the builder menu screen 42.

Menu items selectable in the builder mode M5 are displayed in the menu display area 6 of the builder menu screen 42. A state where an item “DOOR SETTING” for setting a control parameter in the automatic door X1 out of four menu items is selected is displayed on the builder menu screen 42.

The builder can select any one of the four menu items displayed in the menu display area 6 by pressing the direction key K1 indicating the upward or downward direction an arbitrary number of times in a state where the builder menu screen 42 is displayed on the display 300.

Further, when the direction key K1 indicating the rightward direction is pressed in the state where the builder menu screen 42 is displayed on the display 300, the builder menu screen 42 transitions to a large item selection screen 43.

Here, FIG. 13 shows a large item selection screen 44 which is a predetermined page screen of the large item selection screen 43. The large item selection screen 44 includes a screen name display area 1, a menu display area 6 and a non-display area S1 similarly to the builder menu screen 42.

Characters “DOOR SET.” as character information representing that the current screen is a screen relating to an item “DOOR SETTING” on the builder menu screen 42 and the number of pages of the large item selection screen 44 are displayed in the screen name display area 1 of the large item selection screen 44.

Large items, the settings of which are changeable, are displayed in the item “DOOR SETTING” in the menu display area 6 of the large item selection screen 44. A state where an item “SPEED & TIME” for setting an opening/closing speed of the door body 11 and an open/close holding time is selected out of four large items is displayed on the large item selection screen 44.

The builder can select any one of the four large items displayed in the menu display area 6 and cause the large item selection screen 44 to transition to the next page of this large item selection screen 44 by pressing the direction key K1 indicating the upward or downward direction an arbitrary number of times in a state where the large item selection screen 44 is displayed on the display 300.

Further, when the direction key K1 indicating the rightward direction is pressed in the state where the large item selection screen 44 is displayed on the display 300, the large item selection screen 44 transitions to a small item selection screen 45.

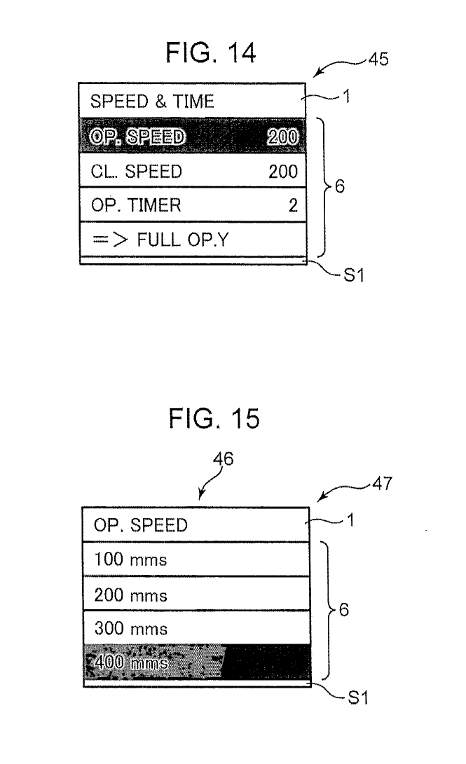

Here, FIG. 14 shows a small item selection screen 45. The small item selection screen 45 includes a screen name display area 1, a menu display area 6 and a non-display area S1 similarly to the large item selection screen 43.

Characters “SPEED & TIME” is displayed as character information representing that the current screen is a screen relating to the item “SPEED & TIME” on the large item selection screen 44 in the screen name display area 1 of the small item selection screen 45.

Small items, the settings of which are changeable, are displayed in the item “SPEED & TIME” in the menu display area 6 of the small item selection screen 45. A state where an item “OP. SPEED” for setting an opening speed of the door body 11 is selected out of four small items is displayed on the small item selection screen 45. Further, character information “200 (mms)” is displayed as the current opening speed of the door body 11 in this item “OP. SPEED”.

The builder can select any one of the four small items displayed in the menu display area 6 by pressing the direction key K1 indicating the upward or downward direction an arbitrary number of times in a state where the small item selection screen 45 is displayed on the display 300.

Further, when the direction key K1 indicating the rightward direction is pressed in the state where the small item selection screen 45 is displayed on the display 300, the small item selection screen 45 transitions to a parameter setting screen 46.

Here, FIG. 15 shows a parameter setting screen 47 which is a predetermined page screen of the parameter setting screen 46. The parameter setting screen 47 includes a screen name display area 1, a menu display area 6 and a non-display area S1 similarly to the small item selection screen 45.

Characters representing “OP. SPEED” on the small item selection screen 45 are displayed in the screen name display area 1 of the parameter setting screen 47.

Parameters selectable in the item “OP. SPEED” are displayed in the menu display area 6 of the parameter setting screen 47. A state where an item “400 mms” is selected out of four parameter items is displayed on the parameter setting screen 47.

The builder can select any one of the four parameter items displayed in the menu display area 6 and cause the parameter setting screen 47 to transition to the next page of this parameter setting screen 47 by pressing the direction key K1 indicating the upward or downward direction an arbitrary number of times in a state where the parameter setting screen 47 is displayed on the display 300.

Further, when the enter key K2 is pressed in the state where the parameter setting screen 47 is displayed on the display 300, the opening speed of the door body 11 is set at 400 mms and the parameter setting screen 47 transitions to the small item selection screen 45. Note that the parameter setting screen 47 can be caused to transition to the small item selection screen 45 without parameter setting by pressing the direction key K1 indicating the leftward direction in the state where the parameter setting screen 47 is displayed on the display 300.

Then, when the direction key K1 indicating the leftward direction is pressed in the state where the small item selection screen 45 is displayed on the display 300, the small item selection screen 45 transitions to large item selection screen 44. By subsequently pressing the direction key K1 indicating the leftward direction, the large item selection screen 44 transitions to a save screen 48.

The save screen 48 is a screen for confirming whether or not the parameter set on the parameter setting screen 47 is to be saved. If the parameter is saved on the save screen 48, the opening speed of the door body 11 is updated from 200 mms as the current opening speed to 400 mms and the save screen 48 transitions to the home screen 31. On the other hand, if the parameter is not saved on the save screen 48, the opening speed of the door body 11 is maintained at 200 mms as the current opening speed and the save screen 48 transitions to the home screen 31.

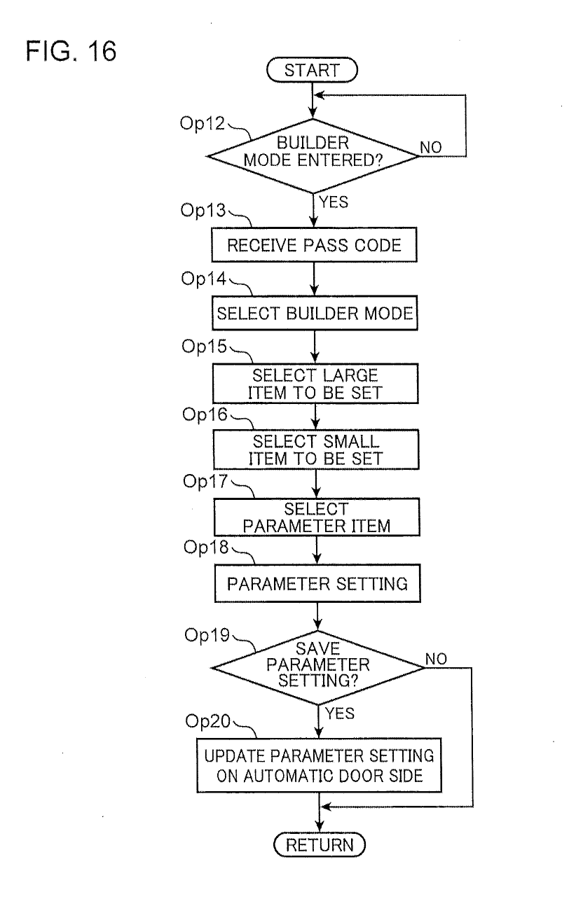

Here, the operation of the switching device Y1 in executing the builder mode M5 is described with reference to a flow chart shown in FIG. 16.

First, the operation is started in the state where the home screen 31 is displayed on the display 300. The input unit 510 determines whether or not a signal for executing the builder mode M5 has been input (Op12) in the state where the home screen 31 is displayed on the display 300. When the user presses the direction key K1 indicating the rightward direction long, a signal for causing the switching device Y1 to function in the builder mode M5 is output from this direction key K1. This signal is also a signal for switching the home screen 31 displayed on the display 300 to another display screen. The input unit 510 sends a command to the screen switching unit 530 to execute the control to switch the home screen 31 to the pass code screen 32 when receiving the above signal (YES in Op12). When the user enters a predetermined pass code by pressing the direction keys K1 and the enter key K2 in the state where the pass code screen 32 is displayed on the display 300, the input unit 510 receives the predetermined pass code (Op13). The input unit 510 having received the predetermined pass code sends a command to the screen switching unit 530 to execute a control to switch the pass code screen 32 to the builder menu screen 42. Then, the user selects the builder menu by pressing the direction key K1 indicating the upward or downward direction in the state where the builder menu screen 42 is displayed on the display 300 (Op14).

Note that, in this embodiment, two second and third pass codes are set as the pass codes for switching the pass code screen 32 to the builder menu screen 42. Specifically, in the switching device Y1, the screen switching unit 530 permits the switch of the home screen 31 to the parameter setting screen 46 via the pass code screen 32, the builder menu screen 42, the large item selection screen 43 and the small item selection screen 45 on the condition that the input unit 510 has received the entry of the second or third pass code. In this embodiment, the builder and the developer can switch the home screen 31 to the parameter setting screen 46, whereas the owner cannot switch the home screen 31 to the parameter setting screen 46.

When the user presses the direction key K1 indicating the rightward direction in the state where the builder menu screen 42 is displayed on the display 300, a signal is output from this direction key K1. The input unit 510 having received the above signal sends a command to the screen switching unit 530 to execute a control to switch the builder menu screen 42 to the large item selection screen 44. Then, the user selects the large item to be set by pressing the direction key K1 indicating the upward or downward direction in the state where the large item selection screen 44 is displayed on the display 300 (Op15).

When the user presses the direction key K1 indicating the rightward direction in the state where the large item selection screen 44 is displayed on the display 300, a signal is output from this direction key K1. The input unit 510 having received the above signal sends a command to the screen switching unit 530 to execute a control to switch the large item selection screen 44 to the small item selection screen 45. Then, the user selects the small item to be set by pressing the direction key K1 indicating upward or downward direction in the state where the small item selection screen 45 is displayed on the display 300 (Op16).

When the user presses the direction key K1 indicating the rightward direction in the state where the small item selection screen 45 is displayed on the display 300, a signal is output from this direction key K1. The input unit 510 having received the above signal sends a command to the screen switching unit 530 to execute a control to switch the small item selection screen 45 to the parameter setting screen 47. Then, the user selects the parameter item by pressing the direction key K1 indicating upward or downward direction in the state where the parameter setting screen 47 is displayed on the display 300 (Op17).

When the user presses the enter key K2 in the state where the parameter setting screen 47 is displayed on the display 300, a signal is output from this enter key K2. The input unit 510 having received the above signal sends a command to the setting/commanding unit 520 to execute a control to set the opening speed of the door body 11 of the automatic door X at 400 mms and sends a command to the screen switching unit 530 to execute a control to switch the parameter setting screen 47 to the small item selection screen 45. At this time, the screen switching unit 530 executes a control to display a character “400 (mms)” as character information representing the current opening seed of the door body 11 in the item “OP. SPEED” of the small item selection screen 45. In this way, the user sets the control parameter of the operation mode by pressing the enter key K2 in the state where the parameter setting screen 47 is displayed on the display 300 (Op18).

When the user presses the direction key K1 indicating the leftward direction in the state where the small item selection screen 45 is displayed on the display 300, a signal is output from this direction key K1. The input unit 510 having received the above signal sends a command to the screen switching unit 530 to execute a control to switch the small item selection screen 45 to the large item selection screen 44.

When the user presses the direction key K1 indicating the leftward direction in the state where the large item selection screen 43 is displayed on the display 300, a signal is output from this direction key K1. The input unit 510 having received the above signal sends a command to the screen switching unit 530 to execute a control to switch the large item selection screen 44 to the save screen 48.

The user determines whether or not to save the parameter setting in Op18 in the state where the save screen 48 is displayed on the display 300 (Op19).

In the case of saving the parameter setting (YES in Op19), the user presses the predetermined direction key K1 and the enter key K2. In this way, a setting save signal is output from these direction key K1 and enter key K2 and received by the input unit 510. The input unit 510 having received the setting save signal sends a command to the setting/commanding unit 520 to output a signal to the operation mode control unit 15a and sends a command to the screen switching unit 530 to execute a control to switch the save screen 48 to the builder menu screen 42. The setting/commanding unit 520 having received the above command transmits a signal for updating the opening speed of the door body 11 from 200 mms to 400 mms to the operation mode control unit 15a via the transmitter/receiver units 700 and 15c. Then, the operation mode control unit 15a having received the above signal executes a control to update the opening speed of the door body 11 from 200 mms to 400 mms (Op20).

On the other hand, in the case of not saving the parameter setting (NO in Op19), the user presses the predetermined direction key K1 and the enter key K2. In this way, a signal is output from these direction key K1 and enter key K2 and received by the input unit 510. The input unit 510 having received the above signal sends a command to the screen switching unit 530 to execute a control to switch the save screen 48 to the builder menu screen 42.

Thereafter, when the user presses the direction key K1 indicating the leftward direction in the state where the builder menu screen 42 is displayed on the display 300, a signal is output from this direction key K1. The input unit 510 having received the above signal sends a command to the screen switching unit 530 to execute a control to switch the builder menu screen 42 to the home screen 31.

By displaying the home screen 31 again on the display 300 in this way, the builder mode M5 is finished.

Next, a transition of screens displayed on the display 300 in the case of executing the developer mode M6 is described. The developer mode M6 is a mode mainly for the developer of the automatic door X1 to confirm detailed information of the automatic door X1.

When the direction key K1 indicating the leftward direction out of the four direction keys of UP, DOWN, LEFT and RIGHT is pressed long in the state where the home screen 31 is displayed on the display 300, the developer mode M6 is executable.

Specifically, when the direction key K1 indicating the leftward direction is pressed long in the state where the home screen 31 is displayed on the display 300, the home screen 31 transitions to the pass code screen 32. Then, the developer of the switching device Y1 enters a predetermined pass code by operating the direction keys K1 and the enter key K2 in the state where the home screen 31 is displayed on the display 300. In this way, the pass code screen 32 transitions to a detailed information screen 49. Note that the pass code screen 32 may not be provided and the home screen 31 may transition to the detailed information screen 49 by pressing the direction key K1 indicating the leftward direction long in the state where the home screen 31 is displayed on the display 300.

The detailed information screen 49 is, for example, a screen on which status information, error information or the like of the operation program of the automatic door is displayed. Note that information on a motor current in the motor with encoder 27 or the like may be, for example, displayed on the detailed information screen 49.

When the direction key K1 indicating the rightward direction is pressed in the state where the detailed information screen 49 is displayed on the display 300, the detailed information screen 49 transitions to the home screen 31.

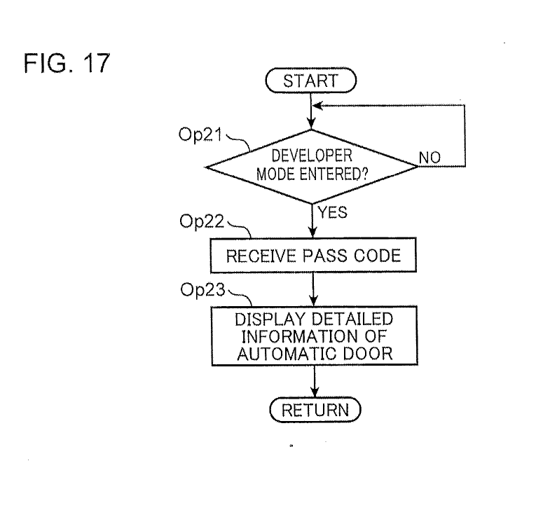

Here, the operation of the switching device Y1 in executing the developer mode M6 is described with reference to a flow chart shown in FIG. 17.

First, the operation is started in the state where the home screen 31 is displayed on the display 300. The input unit 510 determines whether or not a signal for executing the developer mode M6 has been input (Op21) in the state where the home screen 31 is displayed on the display 300. When the user presses the direction key K1 indicating the leftward direction long, a signal for causing the switching device Y1 to function in the developer mode M6 is output from this direction key K1. This signal is also a signal for switching the home screen 31 displayed on the display 300 to another display screen. The input unit 510 sends a command to the screen switching unit 530 to execute the control to switch the home screen 31 to the pass code screen 32 when receiving the above signal (YES in Op21).

When the user enters a predetermined pass code by pressing the direction keys K1 and the enter key K2 in the state where the pass code screen 32 is displayed on the display 300, the input unit 510 receives the predetermined pass code (Op22). The input unit 510 having received the predetermined pass code sends a command to the screen switching unit 530 to execute a control to switch the pass code screen 32 to the detailed information screen 49. In this way, the detailed information screen 49 displayed with the detailed information of the automatic door X1 is displayed on the display 300 (Op23).

Note that, in this embodiment, the third pass code is set as the pass code for switching the pass code screen 32 to the detailed information screen 49. Specifically, in the switching device Y1, the screen switching unit 530 permits the switch of the home screen 31 to the detailed information screen 49 via the pass code screen 32 on the condition that the input unit 510 has received the entry of the third pass code. In this embodiment, the developer can switch the home screen 31 to the detailed information screen 49, whereas the owner and the builder cannot switch the home screen 31 to the detailed information screen 49.

Thereafter, when the user presses the direction key K1 indicating the rightward direction in the state where the detailed information screen 49 is displayed on the display 300, a signal is output from this direction key K1. The input unit 510 having received the above signal sends a command to the screen switching unit 530 to execute a control to switch the detailed information screen 49 to the home screen 31.

By displaying the home screen 31 again on the display 300 in this way, the developer mode M6 is finished.

The switching device Y1 described above includes the display 300 for displaying the home screen 31 and the one-way mode icon A3, which is an icon indicating the current operation mode, is displayed in color on this home screen 31. Thus, even at a position remote from the switching device Y1, the current operation mode of the automatic door X1 can be easily grasped by identifying the color of the one-way mode icon A3 displayed on the home screen 31 on the display 300.

Further, in the switching device Y1, the icons A1 to A5 indicating each of the plurality of operation modes are displayed in colors different from each other when being displayed as the icon indicating the current operation mode on the home screen. Specifically, in this embodiment, the one-way mode icon A3 displayed on the home screen 31 and the two-way mode icon A2 displayed on the home screen 31a are displayed in colors different from each other. Thus, even at a position remote from the switching device Y1, which one of the plurality of operation modes is the current operation mode of the automatic door X1 can be easily grasped by identifying the colors of the icons A2, A3 displayed on the home screens 30, 30a of the display 300.

Furthermore, in the switching device Y1, the icons A1 to A5 indicating each of the plurality of operation modes can be recognized on the operation mode selection screen 33 and a desired operation mode can be selected from the icons A1 to A5 in switching the operation mode of the automatic door X1. Thus, it can be suppressed that the operation mode of the automatic door X1 is erroneously switched to the operation mode different from the desired operation mode.

Furthermore, in the switching device Y1, the two-way mode icon A2 indicating the selected operation mode is displayed larger than the icons A1 and A3 to A5 on the operation mode selection screen 35. Thus, the user can easily identify that the two-way mode icon A2 is currently selected from a size relationship of the icons A1 to A5 displayed on the operation mode selection screen 35. Thus, it can be further suppressed that a switch is erroneously made to the operation mode different from the desired operation mode in switching the operation mode of the automatic door X1.

Furthermore, in the switching device Y1, the two-way mode icon A2 indicating the selected operation mode is displayed in saturation or brightness different from that of the icons A1, A4 and A5 out of the icons A1 and A3 to A5 indicating the unselected operation modes on the operation mode selection screen 35. Further, the two-way mode icon A2 indicating the selected operation mode and the one-way mode icon A3 indicating the current operation mode are displayed in colors different from each other. Thus, the user can easily identify that the two-way mode icon A2 is currently selected and the current operation mode is the one-way mode from the color and the saturation or brightness of each icon A1 to A5 displayed on the operation mode selection screen 35.

Furthermore, in the switching device Y1, the screen name display area 1 of the home screen 31a in the event of an operation abnormality in the automatic door X1 is displayed in color different from that of the screen name display area 1 of the home screen 31 in the event of no operation abnormality in the automatic door X1. Thus, even at a position remote from the switching device Y1, the presence or absence of an operation abnormality in the automatic door X1 can be recognized by identifying the colors of the screen name display areas 1 on the home screens 31, 31a.

Furthermore, in the switching device Y1, the home screen 31 is switched to the operation abnormality screen 39 if there is an operation abnormality in the automatic door X1 when the user of the switching device Y1 tries to switch the home screen 31 to the maintenance information screen 37. The user of the switching device Y1 can judge that the motor of the motor with encoder 27 is in a high temperature state by confirming that the item “THERMAL” in the operation abnormality display area 5 of the operation abnormality screen 39 is displayed in color.

Furthermore, in the switching device Y1, the screen switching unit 530 can execute the control to switch the home screen 31 to the operation mode selection screen 33 via the pass code screen 32. Further, the screen switching unit 530 can also execute the control to switch the home screen 31 to the parameter setting screen 46 via the pass code screen 32, the builder menu screen 42, the large item selection screen 43 and the small item selection screen 45. Further, the screen switching unit 530 can also execute the control to switch the home screen 31 to the detailed information screen 49 via the pass code screen 32. In this way, for example, the owner can switch the operation mode of the automatic door X1 on the operation mode selection screen 33, the builder can set the control parameter of the operation mode of the automatic door X1 on the parameter setting screen 46 and the developer can confirm the detailed information of the automatic door X1 on the detailed information screen 49 in the switching device Y1.

Furthermore, in the switching device Y1, the direction key K1 indicating the upward direction needs to be pressed in the state where the home screen 31 is displayed on the display 300 in the case of causing this switching device Y1 to function in the operation mode switching mode M1. When the direction key K1 indicating the upward direction is pressed, a signal for switching the home screen 31 to the pass code screen 32 is output. Further, the direction key K1 indicating the rightward direction needs to be pressed long in the state where the home screen 31 is displayed on the display 300 in the case of causing this switching device Y1 to function in the builder mode M5. When the direction key K1 indicating the rightward direction is pressed long, a signal for switching the home screen 31 to the pass code screen 32 is output. Further, the direction key K1 indicating the leftward direction needs to be pressed long in the state where the home screen 31 is displayed on the display 300 in the case of causing this switching device Y1 to function in the developer mode M6. When the direction key K1 indicating the leftward direction is pressed long, a signal for switching the home screen 31 to the pass code screen 32 is output. As just described, in the switching device Y1, the direction keys different from each other need to be pressed in the state where the home screen 31 is displayed on the display 300 in causing the switching device Y1 to function in any of the operation mode switching mode M1, the builder mode M5 and the developer mode M6. Thus, it can be suppressed that the owner, the builder and the developer cause the switching device Y1 to function in an erroneous mode.

Furthermore, in the switching device Y1, the first pass code is assigned to the owner of the automatic door, the second pass code is assigned to the builder of the automatic door and the third pass code is assigned to the developer of the automatic door. The first pass code causes the switching device Y1 to function in each of the modes M1 to M4, but cannot cause the builder mode M5 and the developer mode M6 to function. The second pass code causes the switching device Y1 to function in each of the modes M1 to M5, but cannot cause the developer mode M6 to function. The third pass code causes the switching device Y1 to function in each of the modes M1 to M6. Thus, in the switching device Y1, it can be suppressed that the parameter setting of the automatic door X1 is inadvertently changed by the owner and only the developer can confirm the detailed information screen 49 of the automatic door X1.

Furthermore, in the switching device Y1, a plurality of switching signals different from each other can be output from the single one of the direction keys K1 of the operation unit 900. Specifically, in this embodiment, the direction key K1 indicating the leftward direction out of the direction keys K1 output different signals when being pressed long and when being pressed twice. When the input unit 510 receives the signal output by pressing the direction key K1 indicating the leftward direction twice, the screen switching unit 530 switches the home screen 31 to the maintenance information screen 36 or the operation abnormality screen 38 via the pass code screen 32. On the other hand, when the input unit 510 receives the signal output by pressing the direction key K1 indicating the leftward direction long, the screen switching unit 530 switches the home screen 31 to the detailed information screen 49 via the pass code screen 32. As just described, in the switching device Y1, the home screen 31 can be switched to the maintenance information screen 36 or the operation abnormality screen 38 and also to the detailed information screen 49 by operating the direction key K1 indicating the leftward direction. Specifically, the home screen 31 can be switched to any one of a plurality of display screens (maintenance information screen 36, operation abnormality screen 38 and detailed information screen 49) by the direction key K1 indicating the leftward direction as the single operation unit 900. Thus, it is not necessary to provide many operation units 900 and the number of components can be reduced.

Furthermore, in the switching device Y1, the icons A3, B1 displayed in the icon display area 2 of the home screen 31 or the character information displayed in the name display area 3 can be reliably identified even if this switching device Y1 is installed at a high position. Specifically, if the switching device Y1 is installed at a high position, the display 300 needs to be looked up to confirm the home screen 31 displayed on the display 300. At this time, an area of the home screen 31 extending along the lower edge of the casing 100 is hidden behind the casing 100 and cannot be visually confirmed. Accordingly, by setting the area of the home screen 31 extending along the lower edge of the casing 100 as the non-display area S1, various pieces of information displayed on the home screen 31 can be reliably identified.

Note that although the selected icon is displayed larger than the other icons and in color different from that of the other icons on the operation mode selection screen 33 displayed on the display 300 in this embodiment, there is no limitation to this. For example, the selected icon may be only displayed larger than the other icons or may be only displayed in color different from that of the other icons.

Here, the above embodiment is outlined.

An operation mode switching device according to this embodiment is an operation mode switching device for switching an operation mode of an automatic door and includes a display capable of displaying a home screen that displays a current operation mode and an icon display control unit for executing a control to display an icon indicating the current operation mode in color on the home screen.

The above operation mode switching device includes the display for displaying the home screen and the icon indicating the current operation mode is displayed in color on this home screen. Thus, even at a position remote from the operation mode switching device, the current operation mode of the automatic door can be easily grasped by identifying the colors of the icons displayed on the home screen on the display.

The icon display control unit is preferably configured to execute a control to display the icon indicating the current operation mode in color on the home screen out of icons indicating each of a plurality of operation modes. In this case, the icon display control unit is preferably configured to display the icons indicating each of the plurality of operation modes in colors different from each other in displaying the icons on the home screen.

In the above operation mode switching device, the icons indicating each of the plurality of operation modes are displayed in colors different from each other when being displayed as the icon indicating the current operation mode on the home screen. Thus, even at a position remote from the operation mode switching device, it can be easily grasped which of the plurality of operation modes is the current operation mode of the automatic door by identifying the colors of the icons displayed on the home screen on the display.

Note that the icons indicating each of the plurality of operation modes may be displayed in a single color or may be displayed in a combination of a plurality of different colors when being displayed as the icon indicating the current operation mode on the home screen.

The above operation mode switching device preferably further includes a screen switching unit for executing a control to switch the home screen displayed on the display to an operation mode selection screen on which the icons indicating each of the plurality of operation modes are displayed.

In the above operation mode switching device, a user of this operation mode switching device can recognize the icons indicating each of the plurality of operation modes on the operation mode selection screen and select a desired operation mode from the respective icons when switching the operation mode of the automatic door. Thus, it can be suppressed that the operation mode of the automatic door is erroneously switched to the operation mode different from the desired operation mode.

The icon display control unit is preferably configured to execute a control to display the icon indicating the selected operation mode out of the icons indicating each of the plurality of operation modes displayed on the operation mode selection screen larger than the icons indicating the unselected operation modes.

In the above operation mode switching device, the icon indicating the selected operation mode is displayed larger than the icons indicating the unselected operation modes. Thus, the user of the operation mode switching device can easily identify the icon indicating the currently selected operation mode from a size relationship of the icons displayed on the operation mode selection screen. Therefore, it can be further suppressed that the operation mode of the automatic door is erroneously switched to the operation mode different from the desired operation mode in switching the operation mode of the automatic door,

The icon display control unit is preferably configured to execute a control to color-display the icon indicating the current operation mode out of the icons indicating each of the plurality of operation modes displayed on the operation mode selection screen in saturation or brightness different from that of the icons indicating the unselected operation modes.

In the above operation mode switching device, the icon indicating the selected operation mode is color-displayed in saturation or brightness different from that of the icons indicating the unselected operation modes on the operation mode selection screen. Thus, the user of the operation mode switching device can easily recognize the icon indicating the currently selected operation mode from the saturation or brightness of each icon displayed on the operation mode selection screen. Therefore, it can be suppressed that a switch is erroneously made to the operation mode different from the desired operation mode in switching the operation mode of the automatic door.

The icon display control unit is preferably configured to color-display the icon indicating the selected operation mode and the icon indicating the current operation mode out of the icons indicating each of the plurality of operation modes displayed on the operation mode selection screen in saturation or brightness different from that of the icons indicating the other operation modes. In this case, the icon display control unit is preferably configured to display the icon indicating the selected operation mode and the icon indicating the current operation mode in colors different from each other.

In the above operation mode switching device, the icon indicating the selected operation mode and the icon indicating the current operation mode are color-displayed in saturation or brightness different from that of the icons indicating the other operation modes on the operation mode selection screen. Further, the icon indicating the selected operation mode and the icon indicating the current operation mode are displayed in colors different from each other on the operation mode selection screen. Thus, the user of the operation mode switching device can easily recognize the icon indicating the currently selected operation mode and can easily recognize the icon indicating the current operation mode from the color, the saturation or brightness of each icon displayed on the operation mode selection screen.

The above operation mode switching device preferably includes a transmitter/receiver unit for carrying out communication with the automatic door and an abnormality display control unit for executing a control to, when the transmitter/receiver unit receives a signal corresponding to an operation abnormality of the automatic door, display at least a partial area of the home screen in color different from that when the transmitter/receiver unit is not receiving the signal.

In the above operation mode switching device, in the event of an operation abnormality in the automatic door, at least the partial area of the home screen is displayed in color different from that in the event of no operation abnormality in the automatic door. Thus, even at a position remote from the operation mode switching device, the presence or absence of an operation abnormality in the automatic door can be recognized by identifying the color of a predetermined area on the home screen.

The above operation mode switching device preferably includes a transmitter/receiver unit for carrying out communication with the automatic door. In this case, the screen switching unit is preferably configured to confirm the presence or absence of an operation abnormality of the automatic door by carrying out communication with the automatic door via the transmitter/receiver unit and execute a control to switch the home screen displayed on the display to a maintenance information screen in the case of no operation abnormality in the automatic door and switch the home screen displayed on the display to an operation abnormality screen displaying information on an operation abnormality in the case of the operation abnormality in the automatic door.

In the above operation mode switching device, the home screen is switched to the operation abnormality screen if there is an operation abnormality in the automatic door, for example, when the user of the operation mode switching device tries to switch the home screen to the maintenance information screen. The user of the operation mode switching device can recognize the occurrence of a predetermined operation abnormality in the automatic door by confirming operation abnormality information displayed on the operation abnormality screen.

The screen switching unit is preferably configured to execute a control to switch the home screen displayed on the display to a parameter setting screen for setting a control parameter of the operation mode of the automatic door.

In the above operation mode switching device, the screen switching unit can execute the control to switch the home screen to the operation mode selection screen and also the control to switch the home screen to the parameter setting screen. Specifically, the above operation mode switching device not only enables the operation mode of the automatic door to be appropriately switched on the operation mode selection screen, but also enables a builder of the automatic door to set the control parameter of the operation mode on the parameter setting screen.

The above operation mode switching device preferably further includes an input unit for receiving the entry of a first pass code or a second pass code. In this case, the screen switching unit is preferably configured to permit the switch of the screen displayed on the display from the home screen to the operation mode selection screen on the condition that the input unit has received the entry of the first or second pass code and permit the switch of the screen displayed on the display from the home screen to the parameter setting screen on the condition that the input unit has received the entry of the second pass code.

In the above operation mode switching device, the first or second pass code needs to be entered in the input unit in switching the home screen to the operation mode selection screen and the second pass code needs to be entered in the input unit in switching the home screen to the parameter setting screen. Here, the first pass code is, for example, assigned to an owner of the automatic door and the second pass code is, for example, assigned to a builder of the automatic door. Specifically, by entering the first pass code in the input unit, the owner of the automatic door can switch the home screen to the operation mode selection screen, but cannot switch the home screen to the operation mode selection screen. On the other hand, by entering the second pass code in the input unit, the builder of the automatic door can switch the home screen to both of the operation mode selection screen and the parameter setting screen. Thus, it can be suppressed that parameter setting of the automatic door is inadvertently changed by the owner.

The screen switching unit is preferably configured to execute a control to switch the home screen displayed on the display to a detailed information screen displaying detailed information of the automatic door.

In the above operation mode switching device, the screen switching unit can execute the control to switch the home screen to the operation mode selection screen or the parameter setting screen and can also execute the control to switch the home screen to the detailed information screen. Specifically, the above operation mode switching device enables, for example, a developer of the automatic door to confirm the detailed information of the automatic door on the detailed information screen.

The above operation mode switching device preferably further includes an input unit for receiving the entry of a first pass code, a second pass code or a third pass code. In this case, the screen switching unit is preferably configured to permit the switch of the screen displayed on the display from the home screen to the operation mode selection screen on the condition that the input unit has received the entry of the first, second or third pass code, permit the switch of the screen displayed on the display from the home screen to the parameter setting screen on the condition that the input unit has received the entry of the second or third pass code and permit the switch of the screen displayed on the display from the home screen to the detailed information screen on the condition that the input unit has received the entry of the third pass code.

In the above operation mode switching device, for example, the first pass code is assigned to the owner of the automatic door, the second pass code is assigned to the builder of the automatic door and the third pass code is assigned to the developer of the automatic door. Specifically, by entering the first pass code in the input unit, the owner of the automatic door can switch the home screen to the operation mode selection screen, but cannot switch the home screen to the parameter setting screen and the detailed information screen. Further, by entering the second pass code in the input unit, the builder of the automatic door can switch the home screen to the operation mode selection screen and the parameter setting screen, but cannot switch the home screen to the detailed information screen. Further, by entering the third pass code in the input unit, the developer of the automatic door can switch the home screen to any of the operation mode selection screen, the parameter setting screen and the detailed information screen. Thus, it can be suppressed that parameter setting of the automatic door is inadvertently changed by the owner and only the developer can confirm the detailed information screen of the automatic door.

The above operation mode switching device preferably further includes a single operation unit capable of outputting a plurality of switching signals different from each other. In this case, the screen switching unit is preferably configured to receive one switching signal output from the single operation unit out of the plurality of switching signals and execute a control to switch the home screen displayed on the display to a display screen corresponding to the one switching signal out of a plurality of display screens reachable from the home screen.

In the above operation mode switching device, the single operation unit can output a plurality of switching signals different from each other. These switching signals correspond to the plurality of display screens reachable from the home screen. The screen switching unit receives one switching signal out of the plurality of switching signals and executes the control to switch the home screen to the display screen corresponding to the one switching signal. As just described, since the home screen can be switched to any one of the plurality of display screens by the operation of the single operation unit in the above operation mode switching device, it is not necessary to provide many operation units and the number of components can be reduced.

The above operation mode switching device preferably further includes a casing provided to surround the display. In this case, the home screen displayed on the display preferably includes a non-display area extending along a lower edge of the casing.

If the operation mode switching device is installed at a high position, the display needs to be looked up to confirm the home screen displayed on the display. Here, the display is surrounded by the casing in the above operation mode switching device. Thus, when the owner looks up at the display, an area of the home screen extending along the lower edge of the casing is hidden behind the casing and cannot be visually confirmed. Accordingly, in the above operation mode switching device, the area of the home screen extending along the lower edge of the casing is set as the non-display area where information such as icons or characters is not displayed. This enables various pieces of information such as icons or characters displayed on the home screen to be reliably identified even if the operation mode switching device is installed at a high position.

This application is based on Japanese Patent application No. 2014-117592 filed in Japan Patent Office on Jun. 6, 2014, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An operation mode switching device for switching an operation mode of an automatic door, comprising:
a display capable of displaying a home screen that displays a current operation mode; and
an icon display control unit for executing a control to display an icon indicating the current operation mode in color on the home screen.

2. An operation mode switching device according to claim 1, wherein the icon display control unit is configured to:
execute a control to display the icon indicating the current operation mode out of icons indicating each of a plurality of operation modes in color on the home screen; and
display the icons indicating each of the plurality of operation modes in colors different from each other in displaying the icons on the home screen.

3. An operation mode switching device according to claim 2, further comprising a screen switching unit for executing a control to switch the home screen displayed on the display to an operation mode selection screen on which the icons indicating each of the plurality of operation modes are displayed.

4. An operation mode switching device according to claim 3, wherein the icon display control unit is configured to execute a control to display the icon indicating a selected operation mode out of the icons indicating each of the plurality of operation modes displayed on the operation mode selection screen larger than the icons indicating a unselected operation modes.

5. An operation mode switching device according to claim 4, wherein the icon display control unit is configured to execute a control to color-display the icon indicating the selected operation mode out of the icons indicating each of the plurality of operation modes in saturation or brightness different from that of the icons indicating the unselected operation modes.

6. An operation mode switching device according to claim 4, wherein the icon display control unit is configured to color-display the icon indicating the selected operation mode and the icon indicating the current operation mode out of the icons indicating each of the plurality of operation modes displayed on the operation mode selection screen in saturation or brightness different from that of the icons indicating the other operation modes and execute a control to display the icon indicating the selected operation mode and the icon indicating the current operation mode in colors different from each other.

7. An operation mode switching device according to claim 3, further comprising:
a transmitter/receiver unit for carrying out communication with the automatic door; and
an abnormality display control unit for executing a control to, when the transmitter/receiver unit receives a signal corresponding to an operation abnormality of the automatic door, display at least a partial area of the home screen in color different from that when the transmitter/receiver unit is not receiving the signal.

8. An operation mode switching device according to claim 3, further comprising a transmitter/receiver unit for carrying out communication with the automatic door, wherein:
the screen switching unit is configured to confirm the presence or absence of an operation abnormality of the automatic door by carrying out communication with the automatic door via the transmitter/receiver unit and execute a control to switch the home screen displayed on the display to a maintenance information screen in the case of no operation abnormality in the automatic door and switch the home screen displayed on the display to an operation abnormality screen displaying information on an operation abnormality in the case of the operation abnormality in the automatic door.

9. An operation mode switching device according to claim 3, wherein the screen switching unit is configured to execute a control to switch the home screen displayed on the display to a parameter setting screen for setting a control parameter of the operation mode of the automatic door.

10. An operation mode switching device according to claim 9, further comprising an input unit for receiving the entry of a first pass code or a second pass code, wherein:
the screen switching unit is configured to permit the switch of the screen displayed on the display from the home screen to the operation mode selection screen on the condition that the input unit has received the entry of the first or second pass code and permit the switch of the screen displayed on the display from the home screen to the parameter setting screen on the condition that the input unit has received the entry of the second pass code.

11. An operation mode switching device according to claim 9, wherein the screen switching unit is configured to execute a control to switch the home screen displayed on the display to a detailed information screen displaying detailed information of the automatic door.

12. An operation mode switching device according to claim 11, further comprising an input unit for receiving the entry of a first pass code, a second pass code or a third pass code, wherein:
the screen switching unit is configured to permit the switch of the screen displayed on the display from the home screen to the operation mode selection screen on the condition that the input unit has received the entry of the first, second or third pass code, permit the switch of the screen displayed on the display from the home screen to the parameter setting screen on the condition that the input unit has received the entry of the second or third pass code and permit the switch of the screen displayed on the display from the home screen to the detailed information screen on the condition that the input unit has received the entry of the third pass code.

13. An operation mode switching device according to claim 3, further comprising a single operation unit capable of outputting a plurality of switching signals different from each other, wherein:
the screen switching unit is configured to receive one switching signal output from the single operation unit out of the plurality of switching signals and execute a control to switch the home screen displayed on the display to a display screen corresponding to the one switching signal out of a plurality of display screens reachable from the home screen.

14. An operation mode switching device according to claim 1, further comprising a casing provided to surround the display, wherein:
the home screen displayed on the display includes a non-display area extending along a lower edge of the case.
